(19) United States
(12) Patent Application Publication
(10) Pub. No.: US 2020/0344986 A1
(43) Pub. Date: Nov. 5, 2020

(54) SLOTTED FISHING BLADE

(71) Applicant: Queen Tackle LLC, Catawba, NC (US)

(72) Inventor: Jeffrey Carroll Queen, Catawba, NC (US)

(21) Appl. No.: 16/862,053

(22) Filed: Apr. 29, 2020

Related U.S. Application Data
(60) Provisional application No. 62/840,495, filed on Apr. 30, 2019.

(51) Int. Cl. A01K 85/14

(52) U.S. Cl. CPC A01K 85/14; A01K 91/04

(57) ABSTRACT

A slotted fishing blade for attaching to a fishing lure is disclosed. The blade includes a slot that opens from a lower outer edge and extends inwardly along a central longitudinal axis. The blade includes flaps extending from the outer edge that can be folded inwardly to secure a lure attachment element for securing a fishing lure to the plate. When a fishing lure is attached to the blade, the lure is free to move laterally along the lure attachment element. During retrieval of the slotted fishing blade attached to a fishing lure, the blade changes the performance of the lure, for example, by changing the flash, diving depth, or lure action, and/or by adding erratic motion, vibration, or oscillation. The slotted fishing blade may be used on a variety of lures, including hooks with natural baits such as worms or small bait fish.

### CROSS-REFERENCE TO RELATED APPLICATIONS

This application claims priority to U.S. Provisional Patent Application No. 62/840,495 filed on Apr. 30, 2019 by Jeffrey C. Queen entitled “SLOTTED FISHING BLADE,” the entire contents of which are incorporated by reference herein.

### TECHNICAL FIELD

The present invention relates to fishing and, more particularly, to a slotted fishing blade that quickly attaches to a fishing lure.

### BACKGROUND

Blades are attached to the front of fishing jigs during manufacturing to make them less prone to snagging and make jigs more appealing by providing vibration and flash. Positioning the jig close to the front edge of the blade increases controlled action of the oscillating blade while minimizing snagging. Currently, the eye of a fishing jig is attached directly to a hole in the blade. Blades cannot be quickly attached to the jig in the desired position of the blade on the jig.

As can be seen, there is a need for a slotted fishing blade that quickly attaches to a wide variety of fishing lures to enhance fish-catching performance.

### SUMMARY

A slotted fishing blade for attaching to a fishing lure is disclosed. The blade includes a substantially flat plate comprising an outer edge and a slot that opens from the outer edge and extends inwardly along a longitudinal axis of the plate. The blade further includes a plurality of flaps extending from the outer edge of the plate, the flaps being capable of being bent or folded inwardly from the outer edge of the plate, with a folded flap on either side of the slot. The blade further includes a lure attachment element for securing a fishing lure to the plate. The lure attachment element is configured to extend through an attachment point of a fishing lure and is secured to the plate by the flaps and at least one securing hole. When the fishing lure is attached to the plate using the lure attachment element, the fishing lure is free to move laterally along the lure attachment element. The slotted fishing blade attaches to a wide range of fishing lures and changes the performance of any lure to which it is attached, such that the motion of the lure during retrieval is altered. The slotted fishing blade changes the flash, diving depth, lure action, vibration, and/or movement of the lure. The slotted fishing blade may be used to add similar characteristics to hooks coupled with natural baits, such as worms or baitfish.

### BRIEF DESCRIPTION OF THE DRAWINGS

FIG. 1A depicts a rear exploded view of an embodiment of the slotted fishing blade.

FIG. 1B depicts a front exploded view of an embodiment of the slotted fishing blade.

FIG. 1C depicts a side view of an embodiment of the slotted fishing blade.

FIG. 2 depicts a rear view of an embodiment of the slotted fishing blade, shown in use with a weighted jig.

FIG. 3A shows forces that cause the slotted fishing blade to oscillate back-and-forth with the blade positioned in a first position relative to the fishing lure.

FIG. 3B shows forces that cause the slotted fishing blade to oscillate back-and-forth with the blade positioned in a second position relative to the fishing lure.

FIG. 4A depicts the slotted fishing blade attached to the top of a lipless crankbait.

FIG. 4B depicts the slotted fishing blade attached to the front of a metal spoon with the lure eye stamped in metal.

FIG. 5 depicts the slotted fishing blade affixed to the front of a lipped crankbait.

FIG. 6 depicts the slotted fishing blade attached to a spinnerbait.

FIG. 7A depicts the slotted fishing blade attached to the top of an umbrella rig.

FIG. 7B depicts the slotted fishing blade attached to an arm of an umbrella rig with a hook attached to the slotted fishing blade.

FIG. 8 depicts the slotted fishing blade attached to a weighted hook.

FIG. 9 depicts the slotted fishing blade attached to the weighted hook of FIG. 9 during retrieval.

FIG. 10A depicts the slotted fishing blade attached to a first trolling rig.

FIG. 10B depicts the slotted fishing blade attached to a second trolling rig.

FIG. 11 depicts a slotted fishing blade attached to a weighted plastic-molded swimbait.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fishing blade comprising: a substantially flat plate comprising an outer edge and a slot starting at the outer edge and extending inwards; and a lure attachment element configured to secure a fishing lure eye of a fishing lure within the slot of the substantially flat plate.

The present invention includes a slotted fishing blade with a quick attachment. The present invention is fishing lure combination which comprises a lure attachment element and an oscillating blade. The blade has a slot at the center-bottom edge and utilizes a lure attachment element that can be quickly fastened to each side of the blade. The present invention provides quick add-on of a fishing lure while maintaining the improved fishing performance related to the position of the lure and the blade.

The slot in the bottom of the blade and a lure attachment element are utilized to rapidly attach and hold the lure in the desired position. The present invention renders fishermen the ability to quickly attach a blade onto a fishing lure in a position to improve fishing performance. The ease of attaching a blade in the desired position allows a fisherman to efficiently experiment with blade shapes, colors, and sizes on a wide range of fishing lures.

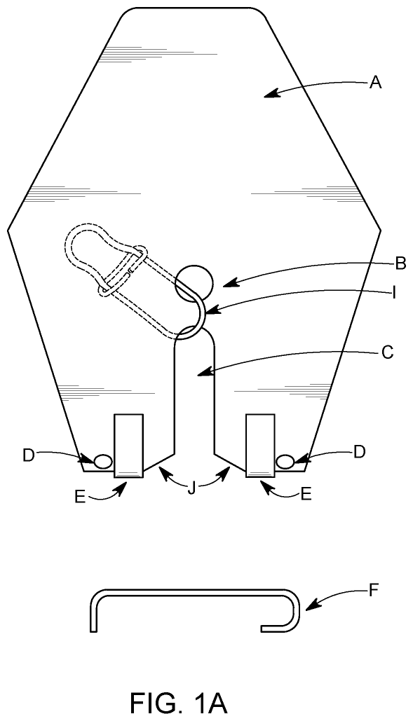

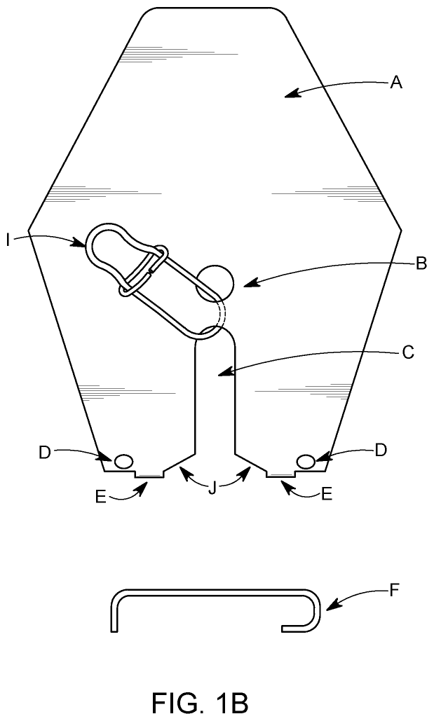

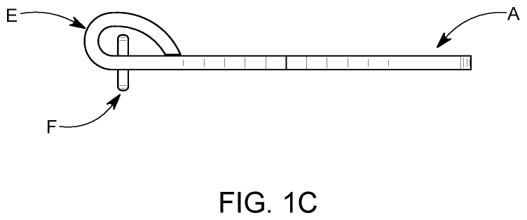

FIGS. 1A-1C depict rear, front, and side exploded views of an embodiment of the slotted fishing blade.

Referring now to FIGS. 1A-1C, the slotted fishing blade may include and may be used with the following elements:

(A): Blade (A) comprises a substantially flat plate that attaches to an attachment point of a fishing lure, which may be located, for example, at the front or near the top of the fishing lure. The blade (A) may be any color, shape, size, width, or material. The purpose of the blade (A) is to oscillate or add other erratic action to the lure during the retrieve and increase the fishing performance of any fishing lure to which the blade is attached by adding flash, altering diving depth, adding vibration, altering lure action, and/or preventing snagging. In addition to lures and jigs, the blade (A) may be used on hooks or trolling rigs to add similar characteristics to natural baits such as worms or bait fish.

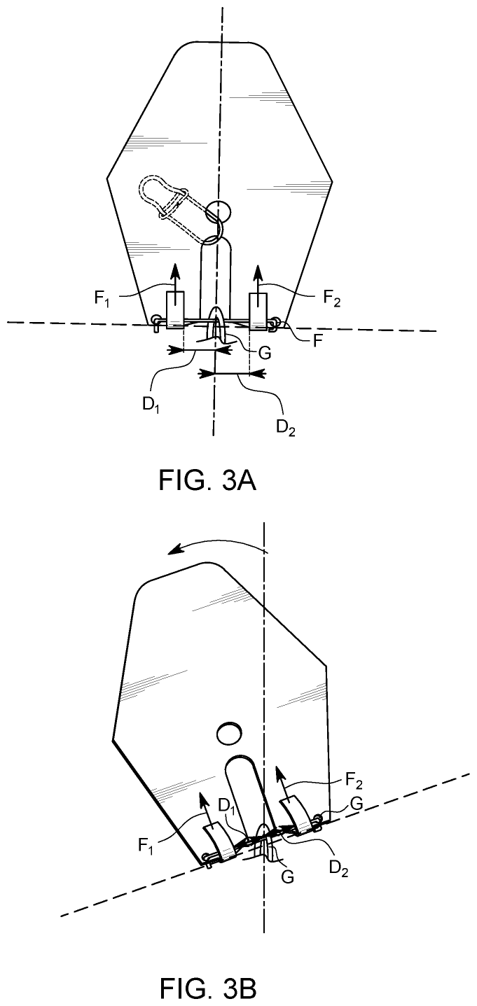

(B): Fastener hole (B) comprises a hole or aperture located along a central longitudinal axis of blade (A) for attaching to a line attachment element (I), such as a line clip, snap swivel, attachment ring, or the like. As can be seen in the embodiment shown in FIGS. 1A and 1B, fastener hole (B) is a single hole located proximate to the distal (or central) end of slot (C) such that the line attachment element (I) passes through both fastener hole (B) and slot (C), as shown in FIGS. 1A and 1B. In other embodiments, two fastener holes (B) may be utilized for attaching to line attachment element (I), with the two fastener holes (B) being located along a central longitudinal axis of the blade (A), or along a latitudinal axis of the blade (A). For reference, a longitudinal axis refers to any vertical axis when looking at the blade as seen in FIGS. 1A and 1B. One example of a longitudinal axis is shown as the dashed vertical line in FIG. 3A. A latitudinal axis refers to any horizontal axis when looking at the blade as seen in FIGS. 1A and 1B. One example of a latitudinal axis is shown as the dashed horizontal line in FIG. 3A. Similarly, references to the bottom of the blade refer to looking at the blade as seen in FIGS. 1A and 1B.

In existing bladed weighted jigs, the blades include two line-attachment holes used in cooperation with a fastener attached to a fishing line for affixing the fishing line to a body of a fishing lure. Line clips or fasteners can be difficult to install, especially while out on the water, and they are often damaged during removal or installation, leading a fisherman to have to take time away from fishing to locate a new fastener and tie it onto the fishing line. As explained above, the slotted fishing blade described herein uses a fastener hole (B) located proximate to the distal end of slot (C) to attach a fastener to the slotted fishing blade by passing the fastener through both fastener hole (B) and slot (C), as shown in FIGS. 1A and 1B. The result of using slot (C) is that the fastener may be moved to either side of the blade (i.e., the front face or the back face) without removing and potentially damaging it, by rotating the fastener around through slot (C) from a front-facing position to a rear-facing position.

(C): Slot (C) comprises a slot that is cut in bottom-center of the blade (A). Slot (C) is used to position the lure eye. As can be seen from FIGS. 1A-1B, slot (C) may be cut such that it opens from the outer edge and extends inwardly along a central longitudinal axis (shown, for example, as a dashed vertical line in FIG. 3A) of the blade (A) from a lower outer edge of the blade (A) toward a central portion of the blade. The transition from the outer edge of blade (A) to the edges (i.e., the vertical side) of slot (C) may be beveled or sloped, as shown in FIGS. 1A and 1B. The beveled or sloped corners (J) allows for a wider opening along the lower outer edge of blade (A) such that the fishing lure eye (G) may travel laterally (i.e., horizontally) along lure attachment element (F) without contacting the bottom edge of the blade during retrieval of the fishing lure. As can be seen in the embodiment shown in FIGS. 1A and 1B, the width of slot (C) approximately matches the diameter of fastener hole (B), and the distal end of slot (C) is rounded to approximately match the curvature of fastener hole (B). The points where the beveled or sloped corners (J) meet the bottom outer edge of blade (A) are approximately aligned with the inner edges of flaps (E), such that the inner edges of flaps (E) begin where the beveled or sloped corners (J) end, as can be seen in FIGS. 1A and 1B. The beveled or sloped corners (J) prevent the fishing lure eye (G) from striking the bottom edge of the blade (A). During retrieval of a lure with the slotted fishing blade attached, the beveled or sloped corners (J) allow for lateral movement of the fishing lure eye (G) without being impeded by the lure eye or lure body contacting the bottom edge of the blade. In existing bladed weighted jigs, the inner diameter of the eye of the weighted jig has been enlarged, as compared to non-bladed weighted jigs, to allow rotational movement of the blade on the eye. The beveled or sloped corners (J) of the slotted fishing blade described herein allow for movement of the blade on a wider range of lures without any special consideration for whether the lure eye needs to be enlarged.

(D): Securing holes (D) are located near the bottom edge of the blade (A) and are used to align and secure the lure attachment element (F). As can be seen in the embodiment shown in FIGS. 1A and 1B, securing holes (D) are located along a latitudinal axis proximate to the bottom outer edge of the blade (A) such that when lure attachment element (F) is secured to securing holes (D), the lure attachment element (F) is secured between flaps (E) and blade (A).

(E): Flaps (E) are an extension of the blade (A) utilized to secure the lure attachment element (F). As can be seen from FIGS. 1A-1C, flaps (E) extend from the bottom outer edge of blade (A) and are bent or folded approximately 180 degrees such that they extend toward the top of blade (A), creating a gap between the surface of flaps (E) and blade (A). When viewed from the side, as shown in FIG. 1C, flaps (E) are curved (or rounded), with the rounded portion positioned slightly lower than the bottom edge of the blade, which is advantageous over the existing blades and lures. The flaps (E) provide a quick and easy way to secure the lure attachment element (F) to the slotted fishing blade. In one embodiment, the flaps (E) are stamped from the same material as the blade, preferably metal, and the material toughness is such that the flaps may be opened and closed multiple times to allow different lures to be attached to the blade. The opening and closing of the flaps may be performed by hand or by using a tool, for example, pliers or nail clippers.

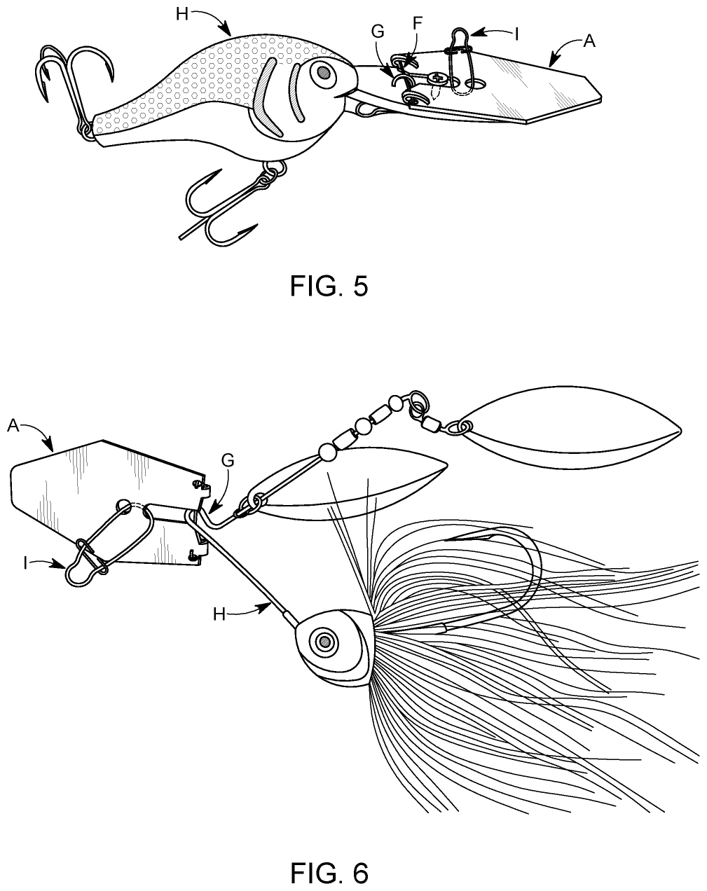

An advantage of the slotted fishing blade described herein is that, with some lures, the rounded portions of flaps (E) of the slotted fishing blade may strike the body of some lures during retrieval, depending on the shape and/or size of the particular lure being used with the slotted fishing blade. For example, the slotted fishing blade would not strike the body of any of the lures shown in FIGS. 5-9 and 10A-10B because of the shapes of the lures.

When the slotted fishing blade described herein is used with fishing lures that strike the blade, any such striking occurs between the fishing lure and the rounded portion of the flaps. By striking the rounded portion of the flaps, the underwater acoustics created are unique compared to existing blades and/or lures. Having different acoustics helps catch fish that have grown accustomed to the sound of other lures.

With existing blade and lure combinations, the striking of the blade and the fishing lure that occurs during retrieval occurs from the impact of the edge of the blade with the jig body. In such existing blades, the edge that strikes the lure is a sharp edge, and fishing lures made of soft metals, such as lead, or plastics, or other soft resins are damaged by the sharp edge of the blade striking the fishing lure. Over time, the damage caused to the fishing lure by the edge of the blade strike the fishing lure degrades the performance of the lure. Thus, by having the rounded or curved portion of the flaps (E) of the slotted fishing blade contacting the lure, damage to the lure is minimized because the rounded or curved portion of the flap does not cut into the lure like the edge of a blade, extending the useful life of the lure.

(F): Lure attachment element (F) comprises a rigid material, typically a wire, that is used to align and secure the fishing lure (H) onto the blade (A). The lure attachment element (F) passes through an attachment point of a fishing lure, such as a fishing lure eye (G), and is fastened to the blade (A) utilizing the bottom holes (D), or the extension flaps (E), or a combination of both the holes (D) and flaps (E). In the embodiment shown in FIGS. 1A-1C, lure attachment element (F) passes through securing holes (D) and is bent or folded back (e.g., using pliers) to secure the lure attachment element (F) in place. The shape of the lure attachment element (F) may vary depending on the method used to attach the lure attachment element (F) to the blade (A) or to change the desired position of the fishing lure (H). The lure attachment element (F) allows the slotted fishing blade to be attached to lure eyes that were difficult or impossible to be attached to existing fishing blades.

The slotted fishing blade described herein offers advantages over various existing lures and blades because the lure attachment element (F) is such that the slotted fishing blade is easily interchangeable when used in a blade/lure combination. In existing lures, an entire blade/lure combination must be disconnected from a fishing line and exchanged with a new blade/lure combination. Such a requirement reduces the combination of blades and lures available within a fisherman's creel or tacklebox. As an example, for a given lure, a silver colored, large blade may be far more effective than a gold colored, small blade at a given fishing moment. For this reason, it may be desirable to exchange blades without changing lures. Likewise, it may be desirable to change lures without changing the blade. The slotted fishing blade described herein provides a way to build new lures quickly, in real-time while fishing, to comprise interchangeable parts.

(G): Fishing lure eye (G) comprises an attachment element of a fishing lure (H) to be attached to the blade (A). The fishing lure eye (G) may be a wire eyelet, a swivel ring, a stamped aperture, or any other element on a fishing lure (H) where a fishing line is meant to be attached to the fishing lure (H).

(H): Fishing lure (H) comprises any fishing lure, jig, or other type of fishing apparatus for catching fish. Fishing lure (H) may include hooks, weighted hooks, weighted jigs, lipless crankbaits, lipped crankbaits, spinnerbaits, spoons, trolling rigs, umbrella rigs, and any other type of lure or jig meant to catch a fish.

(I): Line attachment element (I) comprises any apparatus used for attaching a fishing line, such as a swivel, snap swivel, barrel swivel, a ring, a hand-tied knot, or the like. The line attachment element (I) can be moved to either side of the blade (i.e., the front face or the back face) without removing and potentially damaging the line attachment element (I).

With the slotted fishing blade described herein, a fisherman is able to quickly place the line attachment element (I) such that the blade (A) can be attached to the lure (H) in a position to be above or below the lure eye (G) during retrieval. Whether the blade is above or below the lure eye during retrieval may be used to change the action of the lure. Hence, the fisherman can use the same blade either above or below the lure eye without removing and potentially damaging the line attachment element (I).

Fishermen may desire to change a fastener (e.g., line clip or snap swivel) if it is damaged during use or if a different style/dimension of fastener/clip is desired. It can be difficult for a fisherman to thread a swivel or other style of line clip through the two holes. By using the slot to affix the line clip to the blade, the line clip has a wider range of movement during removal and installation. Thus, the slotted fishing blade disclosed herein is advantageous in that it allows the clip to be installed more quickly and easily. This allows fishermen the ability to quickly change a line clip while minimizing the potential to damage the clip.

The fishing lure eye (G) attaches to the blade (A) using the lure attachment element (F). The lure attachment element (F) is placed through the fishing lure eye (G). The fishing lure eye (G) is centered on the lure attachment element (F). With the fishing lure eye (G) positioned in the slot (C), the lure attachment element (F) is fastened to each side of the blade (A) through holes (D). The slot (C) and the lure attachment element (F) holds the lure in position. The lure attachment element (F) is aligned on the blade (A) by placing said element in the holes (D) for attachment element (F). The lure attachment element (F) is aligned and fastened to the blade (A) by utilizing the holes (D) for attachment element (F). The lure attachment element (F) may be further secured to the blade (A) by using one or more flaps (E) folded over the lure attachment element (F). The fishing lure eye (G) moves freely on the lure attachment element (F) and is held loosely in place along the bottom-center of the blade by the edges of the slot (C). A fisherman can rapidly attach the fishing lure (H) to the blade (A) in a centrally aligned position near the bottom edge of the blade (A) to enhance the fishing performance of the fishing lure (H).

A method of making the slotted fishing lure described herein may include the following. A blade (A) is typically made from metal that is cut or stamped into a substantially flat plate. The blade (A) is made in a shape that allows it to oscillate when attached to a fishing lure (H) and retrieved through the water. The blade (A) is manufactured with a slot (C) centrally located on the bottom of the blade. The body of the blade (A) may also include two flaps (E) or tabs that extend below the bottom edge of the blade (A). One or two holes (B) for line attachment element (I) are cut in the blade (A) to attach a snap or clip used to attach the fishing line to the blade (A). One or two holes (D) for the lure attachment element (F) are cut in blade. A lure attachment element (F) is typically made of wire but could be made of other rigid material. The said lure attachment element (F) can be made in various length, diameter, and shape to centrally locate the fishing lure (H) in the slot for lure eye (C) and fit in the holes for alignment (D).

A method of using the present invention may include the following. A fisherman can rapidly attach a blade to a fishing lure. The attachment element is placed through the eye of a fishing lure. Then the attachment element is placed in the holes for the attachment element with the eye of the lure positioned in the slot. Using pliers, the flaps are bent over the attachment element to secure said element against the blade. The lure eye moves freely on the lure attachment element and is held loosely in place along the bottom-center of the blade by the edges of the slot. A line attachment element is used to attach the line to the lure. The blade oscillates on the lure when retrieved through the water, which includes a fluttering or rotational motion along a longitudinal axis, as well as a side-to-side swaying motion. The blade provides additional movement, such as oscillation, to the lure when retrieved through the water, thereby improving performance of the lure.

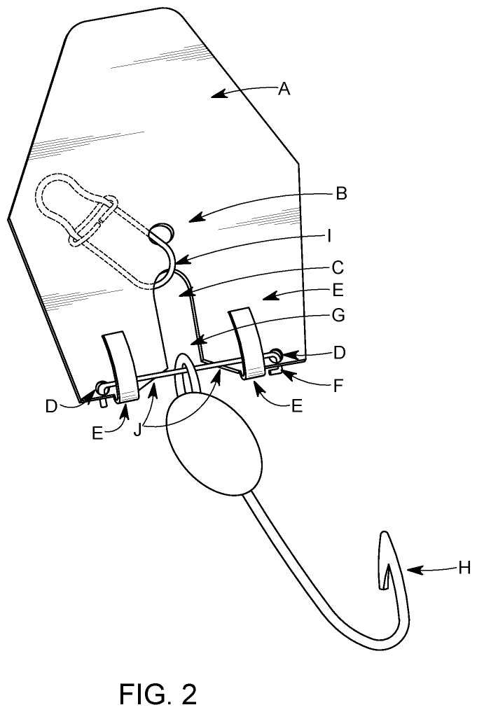

FIG. 2 depicts a rear view of an embodiment of the slotted fishing blade, shown in use with a weighted jig. Referring to FIG. 2, lure attachment element (F) is situated through fishing lure eye (G) of weighted jig (H) and secured into place through holes (D). Flaps (E) are folded around lure attachment element (F) to further hold the lure attachment element (F) in place. Beveled corners (J) of the slot (C) provide room for lateral movement of the fishing lure (H) as the eye (G) of the weighted jig (H) slides on lure attachment element (F). In addition to lateral movement of weighted jig (H), the weighted jig (H) may oscillate and/or vibrate as it slides laterally on the lure attachment element (F).

FIGS. 3A and 3B show forces that cause the slotted fishing blade to vibrate and/or oscillate back-and-forth with the blade positioned relative to the fishing lure. The slotted fishing blade described herein uses a counter-lever mechanism to improve the blade's swaying side-to-side action. The moment action on both sides of a lever is equal and can be expressed with the following equation: F₁D₁=F₂D₂.

Referring to FIG. 3A, the fishing lure eye (G) acts as a fulcrum for the lever. The lure attachment element (F) acts a lever. The weight of the blade including the flaps acts as forces on opposite sides of the fulcrum. As the blade sways side-to side, the eye of the lure (i.e., the fulcrum) moves laterally along the lure attachment element (F). The movement of the blade decreases the distance (D₁) from the lure eye (G) to the position where force (F₁) is being applied to the lure attachment element (G) (i.e., the lever). The change in the distance (D₁) from the fulcrum to the area where force is applied, results in mechanical advantage for the longer distance (D₂). The mechanical advantage results in the force (F₂) on the longer distance (D₂) to swing the position of the lever, as shown in FIG. 3B. As the blade, and hence, the lure attachment element (F) swings, the eye of the lure (G) acting as the fulcrum is repositioned on the lure attachment element (F). The movement of the blade swings the mechanical advantage to the opposite side of the lure attachment element (F), resulting in a reversal in the movement of the blade.

The lure attachment element, because it is a wire bar, acts as a mechanical lever. The fishing lure eye acts a fulcrum of the lever. Because the fishing lure eye is free to move laterally along the lure attachment element, the “up” side of the blade, which is further from the fishing lure eye than the “down” side, gains a mechanical advantage. This mechanical advantage causes the blade to act as a counter-lever mechanism, which allows the blade to function at lure-retrieval speeds that are much slower than is possible with existing blades that lack freedom to move laterally.

Additionally, during retrieval of the lure, the increased degree of movement of the lure eye along the lure attachment element imparts a greater side-to-side swimming action (i.e., a broader range of motion) to the fishing lure and the blade, creating new and improved fish-catching appeal.

In existing bladed weighted jigs, the blade attaches to the fishing lure eye directly to an aperture or circular opening near the bottom edge of the blade. The diameter of the aperture in the blade is slightly larger than the diameter of the wire of the fishing lure eye. In the existing blades, the wire of the lure eye has restricted freedom of movement because it contacts the rounded section of the aperture. The slotted fishing blade described herein uses a slot and the flat horizontal surface of the lure attachment element to allow a greater degree of movement of the lure eye, both laterally and rotationally. The flat horizontal surface of the lure attachment element functions differently than the rounded surface of the aperture in existing blades. The slotted fishing blade described herein provides an innovative way of giving the eye of the lure a greater degree of movement as it moves laterally along the lure attachment element, as well as rotationally on the lure attachment element.

The slotted fishing blade can be rapidly attached to wide range of products after the products have been manufactured (i.e., off the shelf). Traditional bladed lures require that the blade be attached early in the manufacturing process and can result in damage to the lure eye. By adding the blade after manufacturing, the product eyes are not damaged. Thus, fishing lures can be sold without a blade, and the slotted fishing blade described herein allows for the blade to be quickly added to provide bladed lures. As will be apparent to a person of ordinary skill, the slotted fishing blade described herein may be used with wide range of existing fishing lures.

Many existing plastic and metal fishing lures require a blade to be attached after manufacturing. Because the eye of the lure cannot be modified, a blade cannot be attached after the fishing lure has been manufactured. For example, the eye of a lipless crankbait fishing lure cannot be opened after it is molded into the plastic body. Similarly, some fishing lures are stamped from metal, with the eye of the fishing lure being stamped as an aperture in the lure. Thus, the metal aperture cannot reasonably be modified. The slotted fishing blade described herein creates new opportunities for lures that were not possible to connect with previous blade designs.

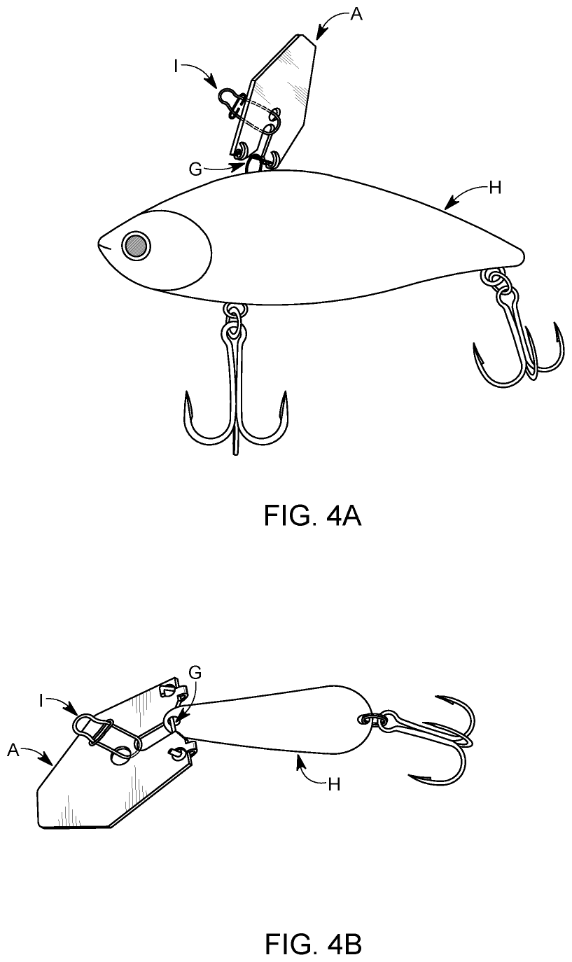

FIG. 4A depicts the slotted fishing blade attached to the top of a lipless crankbait. As can be seen in FIG. 4A, the blade (A) is attached to the eyelet (G) of lure (H). During retrieve, the blade (A) angles slightly backward, as shown in the example of FIG. 4A, and the slotted fishing blade imparts additional erratic motion on the lipless crankbait (H) by vibrating in a side-to-side, or oscillating, motion.

FIG. 4B depicts the slotted fishing blade attached to the front of a metal spoon with the lure eye stamped in metal. As can be seen in FIG. 4B, the slotted fishing blade is attached to the metal spoon (H) in a configuration such that the blade is angled downward during retrieval of the lure. Note that, as shown in FIG. 4B, the slotted fishing blade described herein may be used with an aperture stamped in metal, which allows for addition of the blade after the spoon has been manufactured.

FIG. 5 depicts the slotted fishing blade attached to the front of a lipped crankbait. As shown in FIG. 5, the slotted fishing blade may be affixed to the existing lip of a lipped crankbait using lure attachment element (F). In some embodiments, the blade may be further secured to the existing lip of the crankbait with a small screw or other means of affixing it, as shown in FIG. 5. The screw attaches to the lip to hold the blade in place relative to the lure, such that as the blade wobbles or oscillates, the entire lure wobbles or oscillates along with it. By affixing the slotted fishing blade over the lure's existing lip, the size and/or shape of the lip may be changed, thereby altering the performance of the lipped crankbait. For example, the slotted fishing blade may be used to change the lipped crankbait from a round lip to a coffin lip, which changes the flash, vibration, diving depth, and/or ability to deflect off of structures during retrieval. Similarly, the slotted fishing blade may be used to change from a small coffin lip to a larger coffin lip. One advantage of using the slotted fishing blade in this manner is that it allows an existing lipped crankbait with a broken lip to be repaired by adding a blade to act as a new lip.

There are lures that have wires that extend from the body of the lure. It would be desirable to add a blade to these lures to create more fish catching appeal. An example is a spinnerbait. FIG. 6 depicts the slotted fishing blade attached to a spinnerbait. Referring to FIG. 6, blade (A) attaches to the eye (G) of the spinnerbait (H). The slotted fishing blade creates additional action of the spinnerbait during retrieve.

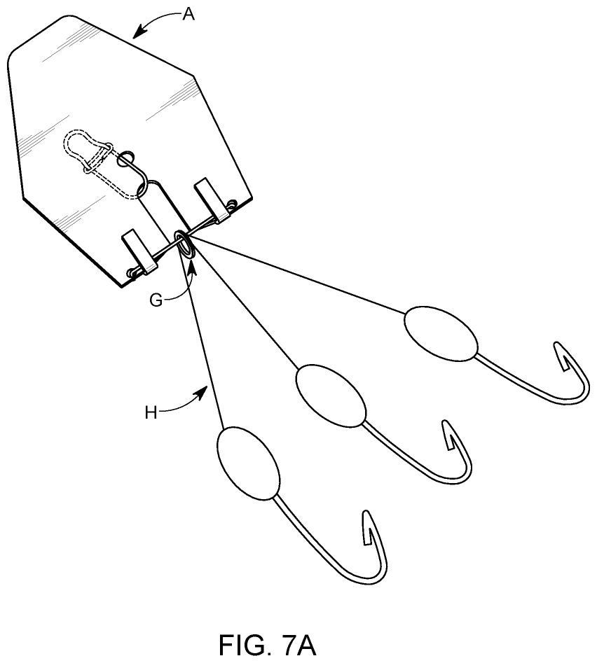

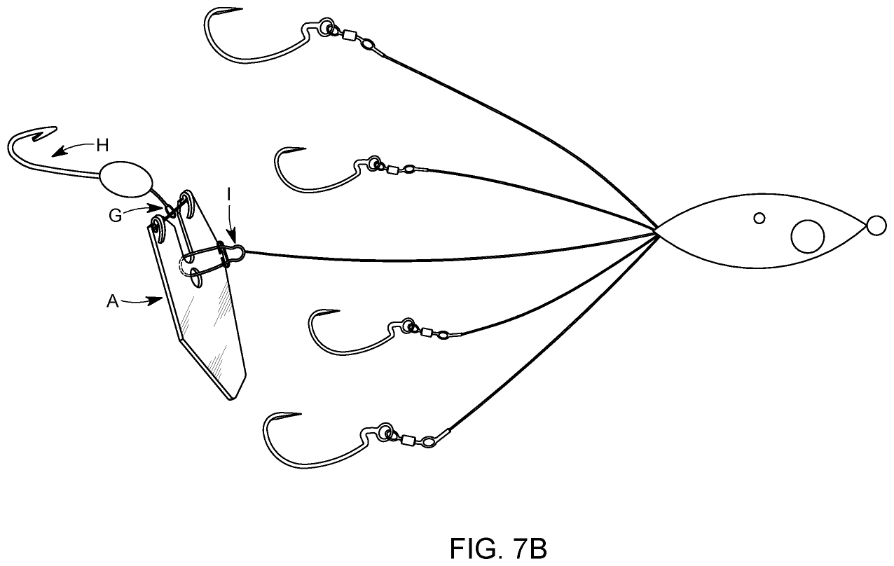

FIG. 7A depicts the slotted fishing blade attached to the top of an umbrella rig.

FIG. 7B depicts the slotted fishing blade attached to an arm of an umbrella rig with a hook attached to the slotted fishing blade. Umbrella rigs use multiple wires and hooks. The slotted fishing blade described herein may be easily added to an umbrella rig without modifying the existing manufacturing processes for an umbrella rig, as shown in FIGS. 7A & 7B. In the configuration shown in FIG. 7A, the slotted fishing blade attached to the top of an umbrella rig adds flash and/or vibration to the umbrella rig. In the configuration shown in FIG. 7B, the slotted fishing blade attached to one or more of the wire arms of the umbrella rig to create erratic action and flash.

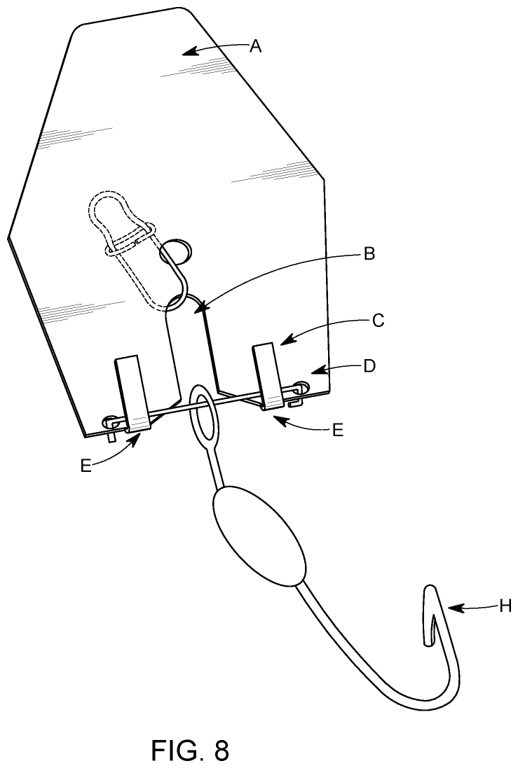

FIG. 8 depicts the slotted fishing blade attached to a weighted hook. Referring to FIG. 8, the operation of the slotted fishing blade (A) on the weighted hook (H) is similar to its operation on a weighted jig, but the blade will not strike the body of the weighted hook during retrieval.

There are a wide range of weighted hook designs that exist or could be created that could be used to attach plastic lures such as crayfish and swimbaits. The weighted hooks are easily attached to the slotted fishing blade described herein without damaging the eye of the hook. The curved section of the blade's flap minimizes damage to the plastic (or other similar soft materials) during retrieval.

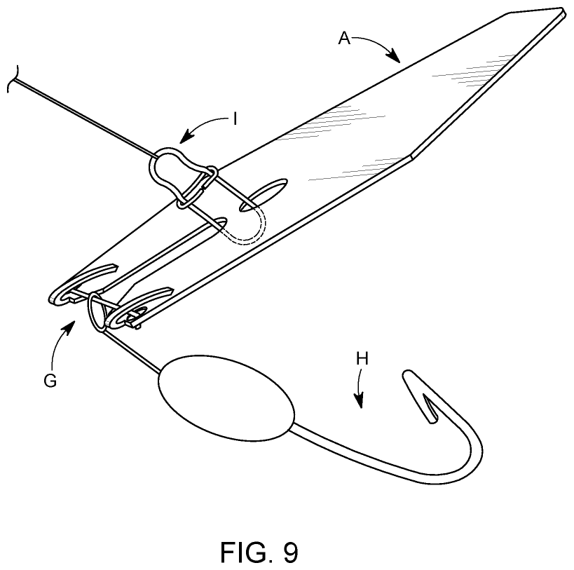

FIG. 9 depicts the slotted fishing blade attached to the weighted hook of FIG. 8 during retrieval.

Referring to FIG. 9, as the slotted fishing blade (A) moves in a side-to-side motion during retrieval, it is positioned at an angle above the weighted hook (H). With the blade (A) oscillating in the angled position shown in FIG. 9, the eye (G) of the hook moves laterally along the lure attachment element, which creates flash and/or vibration of the lure. The lure eye (G) swivels on the lure attachment element.

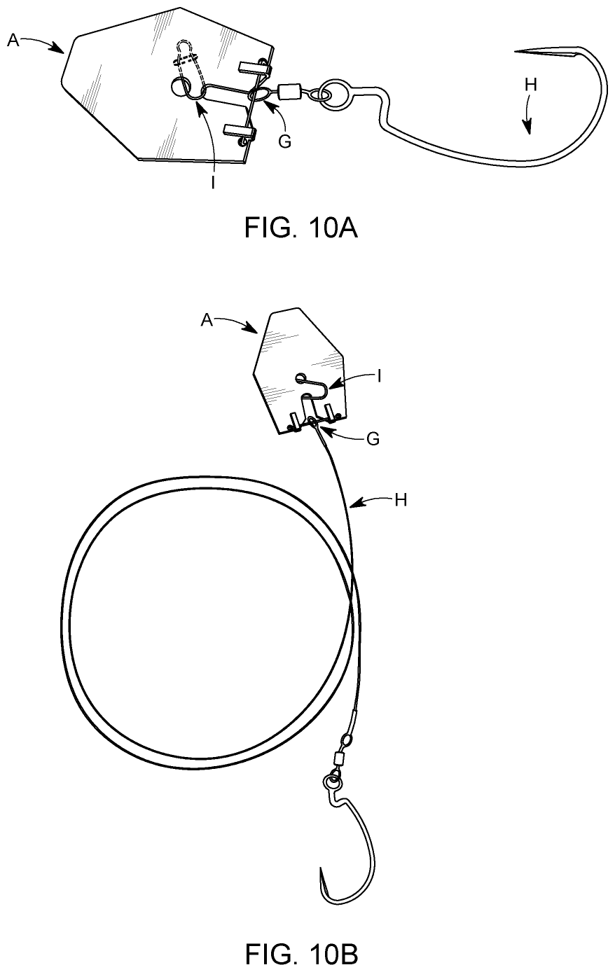

FIGS. 10A and 10B depict the slotted fishing blade attached to trolling rigs. Referring to FIG. 10A, hook (H) is attached to blade (A) using a swivel (G). Referring to FIG. 10B, hook (H) is attached to blade (A) using a leader (G). In the configurations shown in FIGS. 10A and 10B, the slotted fishing blade adds erratic motion to the trolling rigs shown.

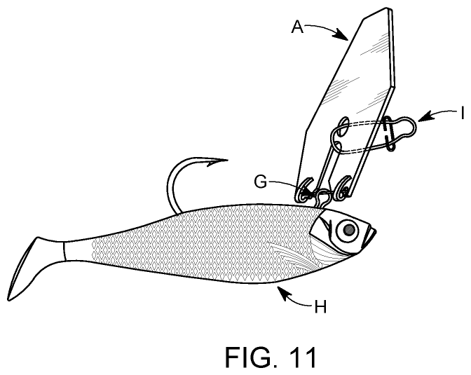

FIG. 11 depicts a slotted fishing blade attached to a weighted plastic-molded swimbait. Referring to FIG. 11, one of the many types of weighted hook designs is the weighted hook with a plastic lure, such as crayfish and swimbaits. The curved section of the blade's flap minimizes damage to the plastic (or other similar soft materials) during retrieval. In other embodiments, the plastic swimbait may be replaced with natural bait, such as a small baitfish.

In alternate embodiments, the attachment element could be reconfigured or made with different materials and achieve the same function. The holes in the blade could be of varying shape or size and achieve the same function. The slot in the blade could be of various shape, width, or length and achieve the same function. The shape, size, color, and material of the blade can be varied to perform the same function. The flaps may be made of a different material than the blade and added or attached to the blade in various configurations to perform the same function as described herein.

It should be understood, of course, that the foregoing relates to exemplary embodiments of the invention and that modifications may be made without departing from the spirit and scope of the invention as set forth in the following claims. While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A fishing blade comprising:
a substantially flat plate comprising an outer edge and a slot starting at the outer edge and extending inward; and
a lure attachment element configured to secure a fishing lure eye of a fishing lure within the slot of the substantially flat plate.

2. The fishing blade of claim 1, further comprising a flap extending outwardly from the outer edge of the substantially flat plate, the flap being capable of being folded inwardly from the outer edge of the plate, with the flap positioned to one side of the slot.

3. The fishing blade of claim 2, wherein the lure attachment element is configured to extend through the fishing lure eye and is secured to the substantially flat plate by the flap and a securing hole.

4. The fishing blade of claim 3, wherein when the fishing lure is attached to the plate using the fishing lure eye, the fishing lure is free to move laterally along the lure attachment element.

5. The fishing blade of claim 1, wherein the substantially flat plate is stamped metal.

6. The fishing blade of claim 1, wherein the substantially flat plate is substantially in the shape of a hexagon.

7. The fishing blade of claim 1, wherein the fishing blade oscillates in a side-to-side motion during retrieval based on a counter lever mechanism created by the fishing blade moving back and forth laterally on the lure attachment element.

8. The fishing blade of claim 1, wherein the slot is positioned proximate to the hole, such that a fastener may be positioned through the hole and the slot simultaneously.

9. The fishing blade of claim 1, wherein the lure attachment element is removable.

10. The fishing blade of claim 1, wherein the flap is bendable.

11. The fishing blade of claim 1, wherein the slot includes sloped corners at the outer edge of the blade such that the slot is wider at the outer edge of the blade than internal to the blade.

12. A blade for attaching to a fishing lure, the blade comprising:
a substantially flat plate comprising an outer edge, a slot that opens from the outer edge and extends inwardly along a central longitudinal axis of the plate, and a fastener hole located along the central longitudinal axis proximate to a distal end of the slot;
a plurality of flaps extending from the outer edge of the plate, the flaps being capable of being folded inwardly from the outer edge of the plate, with one folded flap on either side of the slot;
a lure attachment element for securing a fishing lure to the plate, wherein the lure attachment element is configured to extend through an attachment point of a fishing lure and is secured to the plate by the flaps and at least one securing hole,
wherein, when the fishing lure is attached to the plate using the lure attachment element, the fishing lure is free to move laterally along the lure attachment element.

13. The blade of claim 12, wherein the plate is stamped metal.

14. The blade of claim 12, wherein the plate is substantially in the shape of a hexagon.

15. The blade of claim 12, wherein the blade oscillates in a side-to-side motion during retrieval based on a counter lever mechanism created by the blade moving back and forth laterally on the lure attachment element.

16. The blade of claim 12, wherein the slot is positioned proximate to the hole, such that a fastener may be positioned through the hole and the slot simultaneously.

17. The blade of claim 12, wherein the lure attachment element is removable.

18. The blade of claim 12, wherein the flaps are bendable.

19. The blade of claim 12, wherein slot includes beveled corners such that the slot is wider at the outer edge of the blade than internal to the blade.

20. The blade of claim 19, wherein the beveled corners allow lateral movement of the fishing lure without being impeded by contact with the outer edge of the blade.
